(19) United States
(12) Patent Application Publication
(10) Pub. No.: US 2003/0132639 A1
(43) Pub. Date: Jul. 17, 2003

(54) Door-lock, latch-bolt retainer

(76) Inventor: Randolph C. Franklin, Los Angeles, CA (US)

Correspondence Address: ALBERT O COTA, 5460 WHITE OAK AVE, SUITE A-331, ENCINO, CA, 91316, US

(21) Appl. No.: 10/050,012

(22) Filed: Jan. 17, 2002

(51) Int. Cl. E05C 19/18

(52) U.S. Cl. 292/288

(57) ABSTRACT

A door-lock, latch-bolt retainer (10) that is specifically designed to be used by law enforcement personnel to prevent a door from being latched after an initial entry has been made. The retainer (10) which is used in combination with a door (60) having an outside knob (62), an inside knob (64) and a latch bolt (68) consists of a resilient strap (12) having a left edge (20) and a right edge (22). Adjacent the two edges (20, 22) is respectively located a left opening (32) and a right opening (34). When the openings are inserted over the door's outside knob (62) and the inside knob (64) the retainer (10) is attached. The attached retainer maintains the door's latch bolt (68) in a depressed position, thus preventing the door (60) from being latched.

### TECHNICAL FIELD

The invention pertains to the general field of devices which prevent a door from being locked, and, more particularly, to a thin resilient strap that, when attached between an outside knob and an inside knob causes a door latch bolt to remain depressed, thus preventing the door from being locked.

### BACKGROUND ART

One of the most important measures taken by law enforcement and fire department personnel, especially on calls such as domestic violence, is that after entering a dwelling there must remain a means for a back-up unit(s) to gain access to where the initial responding unit is. The most common deterrent to this is that once the initial unit has arrived at a scene and entered a dwelling, it is possible for a door to be shut behind them and locked, thus trapping the initial unit alone in the situation.

In response to this problem many officers have devised methods for maintaining a door in an un-lockable state. The most typical means is by barring the door open with an object placed between the door and the door frame. Unfortunately, this method is pone to not function reliably. Often thy object gets accidently or purposely moved from its location, thereby causing the door to shut.

By not allowing the back-up unit to reach the initial unit, the officers are put in an often serious amount of danger, especially considering they are usually in un-familiar surrounding, dealing with an individual or individuals who may be hostile to the officer's presence.

Obviously, if there were some means of reliably maintaining a door in an un-locked position, a means or device that could be easily carried by an officer and used quickly with ease, it would be a great benefit.

A search of the prior art did not disclose any patent5 that read directly on the instant invention, however, the following U.S. Pat. Nos. were considered related:

| U.S. Pat. No. | INVENTOR | ISSUED |
|---|---|---|
| 5,769,473 | Savis | 23 Jun., 1988 |
| 5,511,284 | Current | 30 Apr., 1996 |
| 5,154,461 | Prescott, et al | 13 Oct., 1992 |
| 4,335,910 | Massie | 22 Jun., 1982 |

### DISCLOSURE OF THE INVENTION

The door-lock, latch-bolt retainer is designed to prevent a latch-bolt door from being locked. The retainer is especially designed to be used by law enforcement personnel to prevent a door, in a house or building from being locked once entry is made into the house or building. When the retainer is not in use it can be easily folded and placed in a pocket.

The retainer is adapted to be used in combination with a door having an outside knob, an inside knob, a faceplate and a latch bolt. The retainer is comprised of a resilient strap having a substantially rectangular shape with a left edge having adjacent thereto a left opening, and a right edge having adjacent thereto a right opening. When the left opening and the right opening are inserted respectively over the door's outside knob and the inside knob, the retainer is attached. The attached retainer maintains the latch bolt in a depressed position, thus preventing the door frame from becoming latched.

The retainer strap can be made in several elongated designs, and the openings can be cut in various geometric designs, as described in the BEST MODE FOR CARRYING OUT THE INVENTION. Additionally, the center section of the strap has sufficient space to allow indicia to be placed thereon. The indicia can include instructions for using the retainer, a word or logo representing the agency using the retainer or other selected indicia.

In view of the above disclosure, it is the primary object of the invention is to produce a door-lock, latch-bolt retainer that can be easily produced, carried, and that provides a Practical method for keeping a door unlocked.

In addition to the primary object of the invention it is also an object of the invention to produce a door-lock, latch-bolt retainer that:

can be made in various sizes to accomodate various doors,

provides a degree of safety for law enforcement personnel entering and exiting a house or building by assuring that the door will remain unlocked when exiting the house or building,

can be made in various colors to designate a particular type or location of a door, and

is cost effective from both a manufacturer and consumer points of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front elevational view of a first design of a door-lock, latch-bolt retainer.

FIG. 2 is a front elevational view of a second design of the door-lock, latch-bolt retainer.

FIG. 3 is a front elevational view of a third design of the door-lock, latch-bolt retainer.

FIG. 4 is a top plan view showing a typical thickness of all the door-lock, latch-bolt retainer designs.

FIG. 5 is a front elevational view of the door-lock, latch-bolt retainer attached between an outside and an inside door knob causing the latch bolt to remain depressed which prevents a door from being locked.

FIG. 6 is a top plan view of the door-lock, latch-bolt retainer attached between an outside and an inside door knob causing the latch bolt to remain depressed which prevents the door from being locked.

FIG. 7 is a perspective view of the door-lock, latch-bolt retainer attached between an outside and an inside door knob causing the latch bolt to remain depressed which prevents the door from being locked.

### BEST MODE FOR CARRYING OUT THE INVENTION

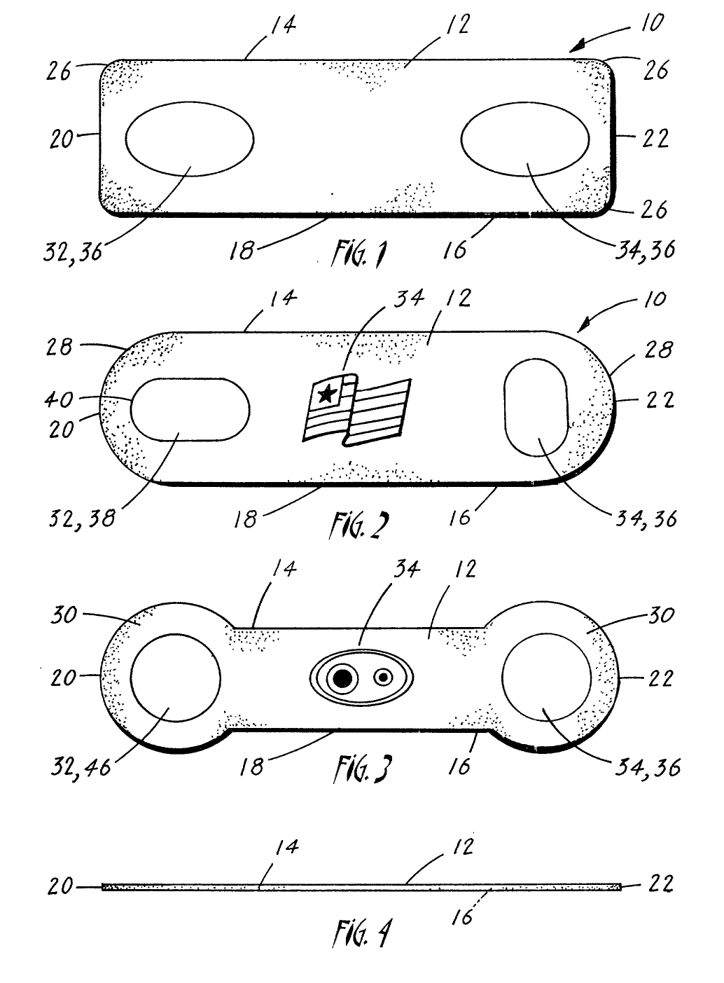

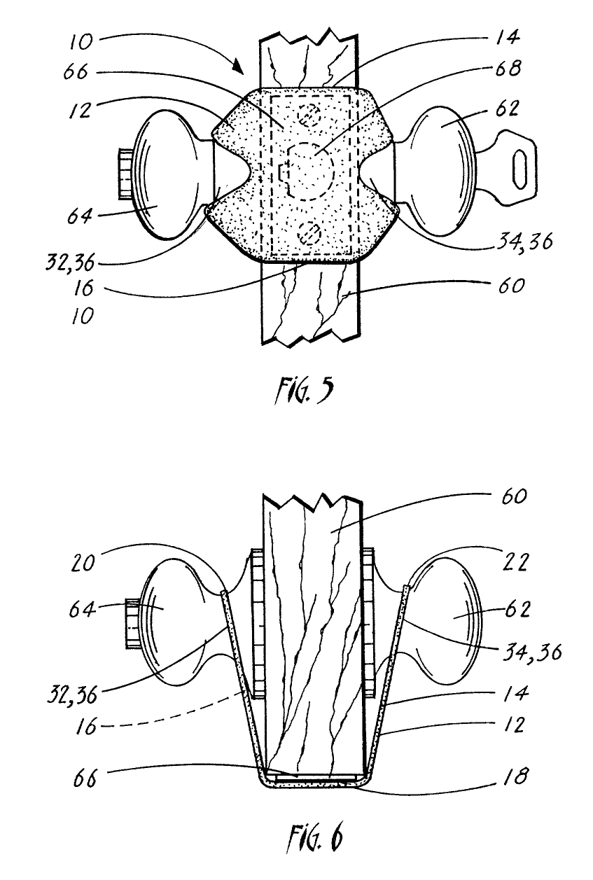

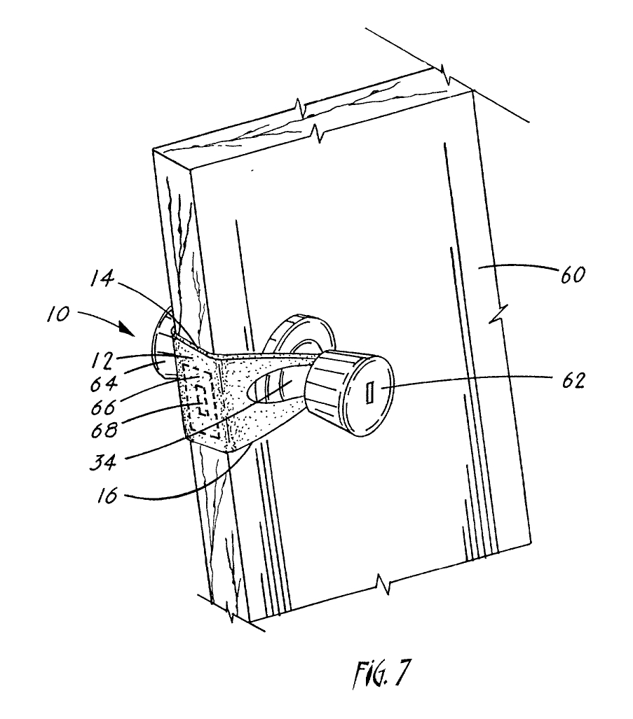

The best mode for carrying out the invention is presented in terms of preferred embodiment for a door-lock, latch-bolt retainer 10. The preferred embodiment of the retainer 10 is shown in FIGS. 1-7, and is comprised of a relatively, thin resilient strap 12 which functions in combination with a door 60 having an outside knob 62, an inside knob 64, a faceplate 66 and a latch bolt 68.

The resilient strap 12, as shown best in FIGS. 1-4, has an upper edge 14, a lower edge 16, a center section 18, a left edge 20 and a right edge 22. The strap 12 is made of an elastic material such as rubber and has the following dimensions: a length between 5.5-6.5-inches (13.97-16.51 cm), a width between 3-4-inches (7.62-10.16 cm) and a thickness between 0.03125-0.125-inches (0.079-0.907 cm). The preferred dimensions are: a length of 6-inches (15.24 cm), a width of 3.5-inches (62.23 cm) and a thickness of 0.0625 (0.159 cm).

The left and right edges 20, 22 are disclosed in three designs. The first design, as shown in FIG. 1, has a left edge 20 and a right edge 22 that have radiused corners 26. The second design, as shown in FIG. 2, has edges 20, 22 that are fully radiused 28. The third design, as shown in FIG. 3, has edges 20, 22 that terminate in a circular section 30.

In addition to the various designs for the left edge 20 and right edge 22, the strap 12 can also be made with openings 32, 34 having various geometric designs. The first opening design, as shown in FIG. 1, consists of a horizontally-oriented, elliptical shape 36. In FIG. 2, the openings 32, 34 can consist of either a horizontally-oriented, elongated shape 38 having radiused ends 40, as shown on the left side of FIG. 2; or the openings can consist of a vertically-oriented, elongated shape 42 having radiused ends 44 as shown on the right side of FIG. 2. Alternatively, in lieu of the radiused end 40, 42, of the elongated openings 38, 42 the ends can be squared with radiused corners (not shown). In FIG. 3 the openings 32, 34 have a circular shape 46 which essentially follows the partial circumference of the left and right edges 20, 22.

To use the door retainer 10, the left opening 32 is first inserted over the outside knob 62 or the inside knob 64. The resilient strap 12 is then stretched and placed over the latch bolt 68 that projects from the faceplate 66. The right opening 26 is then inserted over the respective inside knob 64 or outside knob 62. With the door retainer 10 attached, as shown in FIGS. 5-7, the strap 12 maintains the latch bolt 68 in a depressed positions thus preventing the door from becoming latched when the door is in the normally closed position.

While the invention has been described in complete detail and pictorially shown in the accompanying drawings it is not to be limited to such details, since many changes and modifications may be made to the invention without departing from the spirit and the scope thereof.

1. A door-lock, latch-bolt retainer adapted to be used in combination with a door having an outside knob, an inside knob, a faceplate and a latch bolt, said retainer comprising a resilient strap having a substantially rectangular shape with a left edge having adjacent thereto a left opening, and a right edge having adjacent thereto a right opening, wherein when the left opening and the right opening are inserted respectively over the door's outside knob and the inside knob, said retainer is attached, which then maintains the latch bolt in a depressed position, thus preventing the door from being latched.

2. The retainer as specified in claim 1 wherein said resilient strap is made of an elastic material.

3. The retainer as specified in claim 2 wherein said elastic material is comprised of rubber.

4. The retainer as specified in claim 3 wherein said retainer has a length between 5.5-6.5 inches (13.97-16.51 cm), a width between 3-4 inches (7.62-10.16 cm) and a thickness between 0.03125-0.125 inches (0.079-0.907 cm).

5. The retainer as specified in claim 4 wherein the left edge and the right edge have corners that are radiused.

6. The retainer as specified in claim 1 wherein the left and right openings having a substantially elliptical shape.

7. A door-lock, latch-bolt retainer adapted to be used in combination with a door having an outside knob, an inside knob, a faceplate and a latch bolt, said retainer comprising:
a) a resilient strap having an upper edge, a lower edge, a center section, a left edge and a right edge,
b) said left edge having adjacent thereto a left opening, and
c) said right edge having adjacent thereto a right opening, wherein when the left opening is inserted over the outside knob, the strap stretched and placed over the latch bolt projecting from the faceplate, and the right opening is inserted over the inside knob, said retainer is attached, which then maintains the latch bolt in a depressed position, thus preventing the door from being latched.

8. The retainer as specified in claim 7 wherein said resilient strap is made of an elastic material.

9. The retainer as specified in claim 7 wherein said elastic material is comprised of rubber.

10. The retainer as specified in claim 9 wherein said retainer has a length between 5.5-6.5 inches (13.97-16.51 cm), a width between 3-4 inches (7.62-10.16 cm) and a thickness between 0.03125-0.125 inches (0.079-0.907 cm).

11. The retainer as specified in claim 7 wherein the left edge and the right edge have corners that are radiused.

12. The retainer as specified in claim 7 wherein the left edge and the right edge are each fully radiused.

13. The retainer as specified in claim 7 wherein the left edge and the right edge each terminate in a circular section.

14. The retainer as specified in claim 7 wherein the left and right openings having a horizontally-oriented, elliptical shape.

15. The retainer as specified in claim 7 wherein the left and right openings having a vertically-oriented, elongated shape with radiused corners.

16. The retainer as specified in claim 6 wherein the left and right openings having a horizontally-oriented, elongated shape with radiused corners.

17. The retainer as specified in claim 7 wherein the left and right openings have a circular shape.

18. The retainer as specified in claim 7 wherein said center section further comprises indicia.
